(19) United States
(12) Patent Application Publication
(10) Pub. No.: US 2008/0289650 A1
(43) Pub. Date: Nov. 27, 2008

(54) LOW-TEMPERATURE CLEANING OF NATIVE OXIDE

(75) Inventor: Chantal J. Arena, Mesa, AZ (US)

Correspondence Address: Knobbe, Martens, Olson & Bear LLP, 2040 Main Street, 14th Floor, Irvine, CA, 92614, US

(73) Assignee: ASM America, Inc., Phoenix, AZ (US)

(21) Appl. No.: 11/753,453

(22) Filed: May 24, 2007

(51) Int. Cl. B08B 11/00; B01J 19/08; B08B 7/00

(52) U.S. Cl. 134/1.2; 134/1; 134/1.1; 134/1.3; 422/186.3

(57) ABSTRACT

Disclosed herein is a method of cleaning oxide from a surface in the fabrication of an integrated device using reducing radicals and UV radiation. For silicon surfaces, the cleaning may be performed at a temperature at which a hydrogen-terminated passivated surface is stable, such that the surface remains protected after loading into the chamber until the cleaning is performed. Performing the cleaning at a lower temperature also consumes a reduced portion of the thermal budget of a semiconductor device. Epitaxial deposition can then be performed over the cleaned surface.

### BACKGROUND

1. Technical Field

The present disclosure relates to the manufacture of semiconductor devices, and, in particular, to the cleaning of oxide from surfaces during semiconductor fabrication, and for apparatuses therefor.

2. Description of the Related Art

Surfaces of semiconductor substrates on which epitaxial films of silicon or other materials are grown are preferably oxide free. An oxide layer, also referred to as a native oxide layer, typically forms when a clean surface of a semiconductor, and in particular, silicon, is exposed to air. Oxide layers also form on the surfaces of other materials used in integrated device fabrication, for example conductors such as copper. Native oxide on semiconductor surfaces is typically removed prior to deposition using one or more wet cleaning steps. A common method of wet cleaning silicon wafers is performed as follows. An RCA Standard Clean-1 (SC-1) procedure is first performed, which uses a mixture of aqueous ammonia and hydrogen peroxide at 70° C. to dissolve group I and II metals, and organic films. Next, an RCA Standard Clean-2 (SC-2) procedure is performed, which uses a mixture of hydrogen peroxide and hydrochloric acid at 70° C. to remove any remaining metals. Third, oxide chemically grown in the prior steps, may be removed by dipping the wafer into hydrofluoric acid. If this is the last wet cleaning step, it is referred to as an HF last step, which leaves a somewhat protective hydrogen terminated surface.

Despite the wet cleaning, sub-monolayer amounts of oxide may regrow on the semiconductor surface, particularly where the substrates are stored for a prolonged period between the HF last dip and further processing, for example, epitaxial deposition. This oxide is typically removed in situ within a deposition reactor prior to the deposition of an epitaxial layer. The removal of this oxide is also referred to as cleaning the surface. Where the oxide is removed at an elevated temperature, the cleaning process is also referred to as baking-off the oxide, or simply, baking.

Typically, baking is performed under a reducing atmosphere at a temperature at which the reaction rate is acceptable. For silicon surfaces, the temperature is typically above 800° C. At temperatures below about 700° C, the reaction rate is slow enough to negatively impact reactor throughput.

For example, a rapid, low temperature bake has been described in U.S. Patent Publication No. 2003/0036268, published on Feb. 20, 2003, the disclosure of which is incorporated by reference. This reference describes cleaning silicon or silicon-germanium surfaces by baking at from about 700° C. to about 900° C. for about 15 seconds.

One approach to low-temperature cleaning has been to use hydrogen radicals as the reducing species, for example, as described in Takahagi et al., J. Appl. Phys. 1990, 68, 2187, the disclosure of which is incorporated by reference. These hydrogen radicals are produced in a plasma source remote from the deposition chamber. Hydrogen radicals generated in a remote plasma source, while highly reactive, do not damage the substrate surface, in contrast to direct treatment with in situ generated hydrogen plasma, which contains energetic particles such as ions and electrons (for example, the method described in Kishimoto et al., Jpn. J. Appl. Phys. 1990, 29, 2273, the disclosure of which is incorporated by reference). The principal drawback of this method is that the concentration of hydrogen radicals provided by commercially available plasma sources is insufficient to provide acceptable cleaning rates at lower temperatures, in part, because the high silicon-oxygen bond strength limits the efficiency of the reduction reaction.

### SUMMARY OF THE INVENTION

Reduced device sizes translate into decreased vertical dimensions of the device components. Because these smaller devices typically have smaller thermal budgets than their larger predecessors, reducing the temperature at which the oxide is baked-off would be an important process improvement. Lower temperatures are also important in applications that are incompatible with higher temperatures, such as epitaxial silicon/silicon-germanium interfaces, in which defects form at high temperatures. Furthermore, a low-temperature bake would improve reactor throughput because reduced heating and cooling times are needed.

Some embodiments provide a method of cleaning oxide from a surface-to-be-cleaned in the fabrication of an integrated device, the method comprising: contacting a surface-to-be-cleaned comprising oxide with remotely generated reducing radicals, and irradiating the surface-to-be-cleaned with UV radiation.

In some embodiments, the surface-to-be-cleaned is a surface of a semiconductor. In some embodiments, the semiconductor comprises a single-crystal semiconductor. In some embodiments, the semiconductor comprises silicon. In some embodiments, the semiconductor comprises silicon-germanium. In some embodiments, the semiconductor is an epitaxial layer. In some embodiments, the epitaxial layer is supported on a semiconductor. In some embodiments, the epitaxial layer is supported on an insulator. In some embodiments, the insulator comprises at least one of silica and sapphire. In some embodiments, the surface-to-be-cleaned comprises a surface of a conductor. In some embodiments, the conductor comprises copper.

Some embodiments further comprise precleaning the surface-to-be-cleaned prior to the cleaning process. In some embodiments, the precleaning comprises at least one of an ex situ wet cleaning and a dry etch.

Some embodiments further comprise heating the surface-to-be-cleaned. In some embodiments, the surface is heated to a temperature that is not greater than about 550° C. In some embodiments, the temperature is not greater than about 500° C. In some embodiments, the temperature is not greater than about 450° C. In some embodiments, the surface-to-be-cleaned is not heated.

In some embodiments, the reducing radicals comprise hydrogen radicals or excited species generated from a plasma. In some embodiments, the plasma is generated from a plasma source gas comprising hydrogen. In some embodiments, the plasma source gas further comprises an inert gas. In some embodiments, the inert gas comprises at least one of He, Ar, Xe, O₂, Ne, and Kr. In some embodiments, the pressure of the plasma is from about 0.1 torr to about 3 torr. In some embodiments, the concentration of hydrogen radicals is from about 2% to about 100%.

In some embodiments, a hydrogen terminated surface is formed on the surface-to-be-cleaned. Some embodiments further comprise heating the surface-to-be-cleaned to a temperature at which the hydrogen terminated surface is stable.

In some embodiments, the UV radiation is from about 100 nm to about 400 nm. In some embodiments, the UV radiation is from about 146 nm to about 193 nm. In some embodiments, a source of at least a portion of the UV radiation comprises an excimer lamp. In some embodiments, a source of at least a portion of the UV radiation comprises a remote plasma.

Some embodiments further comprise forming a layer on the surface-to-be-cleaned wherein the contacting, irradiating, and forming are performed in a single reaction chamber. In some embodiments, the layer is formed by a method comprising chemical vapor deposition. In some embodiments, the chemical vapor deposition is UV-assisted chemical vapor deposition. In some embodiments, a plasma glow discharge is a source of at least a portion of the UV radiation in the UV assisted chemical vapor deposition. In some embodiments, the plasma is an in situ plasma. In some embodiments, the layer is formed by a method comprising atomic layer deposition. In some embodiments, the layer comprises at least one of epitaxial silicon, epitaxial germanium, or epitaxial silicon-germanium

Some embodiments provide a reactor for fabricating an integrated device, the reactor comprising a source of reducing radicals and a source of UV radiation, wherein the source of UV radiation comprises an excimer UV lamp. Some embodiments further comprise a heat source.

In some embodiments, the source of reducing radicals is a plasma source. In some embodiments, the plasma source is a remote plasma source.

Some embodiments provide a reactor for fabricating an integrated device, the reactor comprising: a plasma chamber, and a reaction chamber dimensioned and configured for processing a substrate therein. The plasma chamber is dimensioned and configured to irradiate a substrate within the reaction chamber with UV radiation generated by a plasma within the plasma chamber, and the plasma chamber is in fluid connection with the reaction chamber.

In some embodiments, the fluid connection between the plasma chamber and the reaction chamber is optimized to provide neutral radicals to the reaction chamber. Some embodiments further comprise an energy source configured to generate a plasma within the plasma chamber.

In some embodiments, at least one of the plasma chamber and reaction chamber comprises quartz. Some embodiments further comprise a heat source dimensioned and configured to heat the substrate. In some embodiments, the heat source is a radiant heat source.

Other embodiments provide a method for cleaning oxide from a surface-to-be-cleaned in the fabrication of an integrated device, the method comprising: contacting a surface-to-be-cleaned with a reducing radical precursor; irradiating the surface-to-be-cleaned with UV radiation suitable for generating a reducing radical from the reducing radical precursor, thereby forming reducing radicals contacting the surface-to-be-cleaned, wherein the reducing radicals effectively clean oxide from the surface-to-be-cleaned. In some embodiments, a source of the UV radiation is an in situ plasma discharge. In some embodiments, substantially none of the reducing radicals contacting the surface-to-be-cleaned are generated in the in situ plasma discharge. In some embodiments, the in situ plasma is generated from a gas comprising hydrogen gas and an inert gas. In some embodiments, the reducing radical precursor is molecular hydrogen.

### BRIEF DESCRIPTION OF THE DRAWINGS

FIG. 1 illustrates a preferred embodiment of a reactor in which the disclosed oxide cleaning method may be performed.

FIG. 2 is a flowchart illustrating a preferred embodiment of the disclosed cleaning procedure.

FIG. 3A illustrates a preferred embodiment of a reactor in which the source of UV radiation is the glow discharge of a plasma.

FIG. 3B and FIG. 3C illustrate alternative configurations for a plasma chamber and heat sources in preferred embodiments of a reactor.

FIG. 4A schematically illustrates a cross section of an embodiment of a reactor in which a source of UV radiation is an in situ plasma. FIG. 4B is a top view of section B of the reactor illustrated in FIG. 4A.

### DETAILED DESCRIPTION OF SOME PREFERRED EMBODIMENTS

The disclosed method, apparatus, and systems are useful for cleaning oxide from a surface of a substrate during semiconductor fabrication using radicals, for example, remotely generated, and UV radiation at reduced temperatures. For silicon surfaces, the cleaning provides a silicon surface terminated with hydrogen, a passivated surface stable to about 500-550° C. At higher temperatures, the hydrogen desorbs from the surface. The passivated surface resists oxidation.

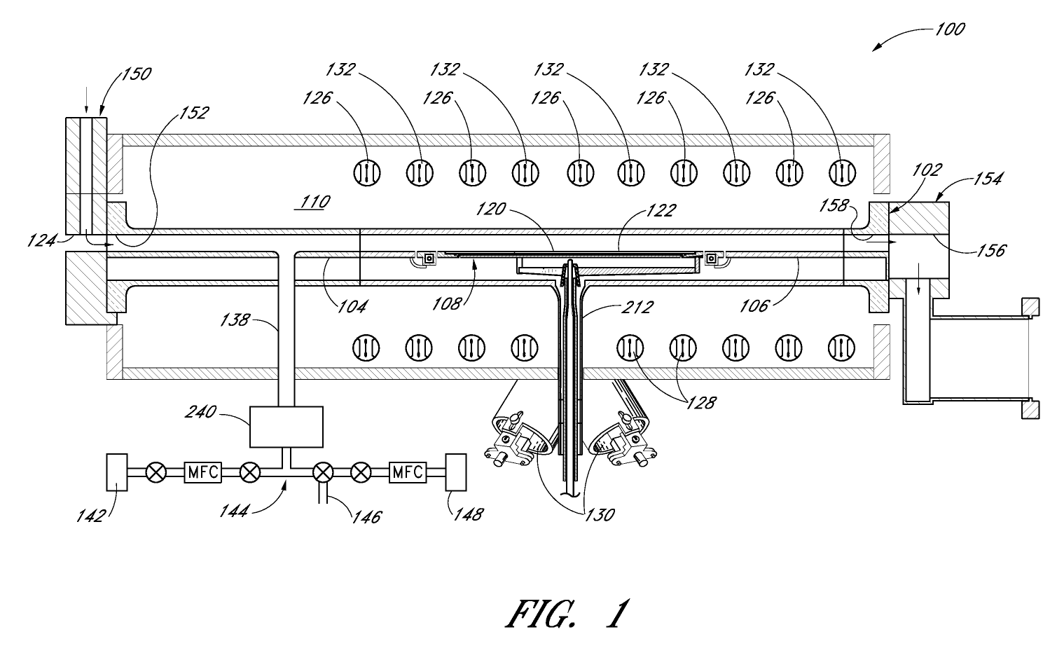

FIG. 1 illustrates a preferred embodiment of a reactor 100 useful for cleaning native oxide. The illustrated reactor 100 is a single-substrate, horizontal flow, cold-wall reactor. Reactors of this type provide improved process control and uniformity compared with batch systems. Such reactors may process only a single, or at most, a handful of substrates at a time, however, reducing throughput. In a batch processing configuration, the substrates are preferably laterally arrayed, facilitating irradiation of the substrates. A commercially available reactor with this basic configuration is sold under the trade name Epsilon® by ASM America, Inc. Phoenix, Ariz. Control of the illustrated reactor 100 is advantageously automated, for example, using a computer or microprocessor (not illustrated).

The illustrated reaction chamber 102 is constructed from quartz. The total volume of a reaction chamber for 100-mm substrates is preferably less than about 30 L, more preferably, less than about 20 L, most preferably, less than about 10 L. The illustrated reactor has a volume of about 7.5 L. The effective volume of the reactor for process gases is about half of this value because of dividers 104 and 106, a wafer holder 108, and a ring 110, and purge gas flowing through a tube 112. Those skilled in the art will realize that the size of the reactor is related to size of the substrate. For example, for a 300-mm substrate, the volume of the reactor is preferably less than about 100 L, more preferably, less than about 60 L, most preferably, less than about 30 L. The illustrated reactor for 300-mm substrates has a volume of about 24 L and an effective volume of about half of that value. Those skilled in the art will realize that the reactor size will increase with an increasing number of substrates that may be simultaneously processed.

A substrate 120 with a surface 122 to be cleaned preferably enters and exits the reaction chamber from a handling chamber (not illustrated) through a slot 124 using a pick-up device of a type well known in the art. Preferably, a gate valve (not illustrated) of any type known in the art separates the reaction chamber from the handling chamber. The pick-up device places and removes the substrate 120 from the wafer holder 108. In the illustrated embodiment, the surface 122 to be cleaned is oriented upwards; however, other configurations, for example, the surface-to-be-cleaned may be at an angle, vertical, or facing downwards, are contemplated.

Positioned above and below the reaction chamber 102 are a plurality of radiant heat sources, 126, 128, and 130 used to heat the substrate 114. Elongated tube type heat sources 126 and 128 are preferably high-intensity tungsten filament halogen lamps with transparent quartz envelopes, which heat-up and cool-down relatively quickly, which are well known in the art. The thermal radiation generated by these sources is transmitted through the walls of reaction chamber 102 without appreciably heating the walls of the chamber. Spot lamps 130 may be used to compensate for the heat sink effects of the wafer support structures. The heat sources are preferably independently controllable.

Interspersed among the heat sources 126 positioned above the reaction chamber 102 are a plurality of UV sources 132. The UV sources 132 are preferably excimer lamps, for example, linear excimer lamps of a type commercially available from Resonance Ltd. (Barrie, Ontario) Other embodiments (not illustrated) have different relative configurations between the UV sources 132 and the heat sources 126. For example, the sources may be arranged in banks, rather than interspersed, or the UV sources 132 may be positioned above and/or below the heat sources 126.

The illustrated reactor 100 is also equipped with a remote plasma generator 140. A source of plasma source gas 142 is in fluid connection with the plasma generator 140, through a manifold 144. In the illustrated embodiment, the flow of the plasma source gas is regulated by a mass flow meter. As described above, the plasma source gas may contain an inert gas. The manifold 144 may also be supplied by additional gas sources, for example, 146 and 148, which may be components of the plasma source gas, or used, for example, for additional process steps or for cleaning the reactor. The plasma inlet 138 fluidly connects the plasma generator 140 with the reaction chamber 102. The plasma inlet 138 is preferably configured to optimize the concentration of reducing radicals delivered to the reaction chamber 102, while minimizing the concentration of damaging energetic particles.

The illustrated reactor 100 is equipped with an inlet assembly 150, through which process gases are supplied to the reaction chamber 102. In the illustrated embodiment, the slot 124 of the inlet assembly 150 is aligned with the inlet port 152 of the reaction chamber 102 to allow insertion and removal of the substrate 120 from the reaction chamber 102. The illustrated reactor 100 is also equipped with an exhaust assembly 154 with an exhaust opening 156 aligned with the exhaust port 158 of the reaction chamber 102. Process gases are drawn from the reaction chamber 102 through the exhaust assembly 154, typically by a vacuum source (not illustrated).

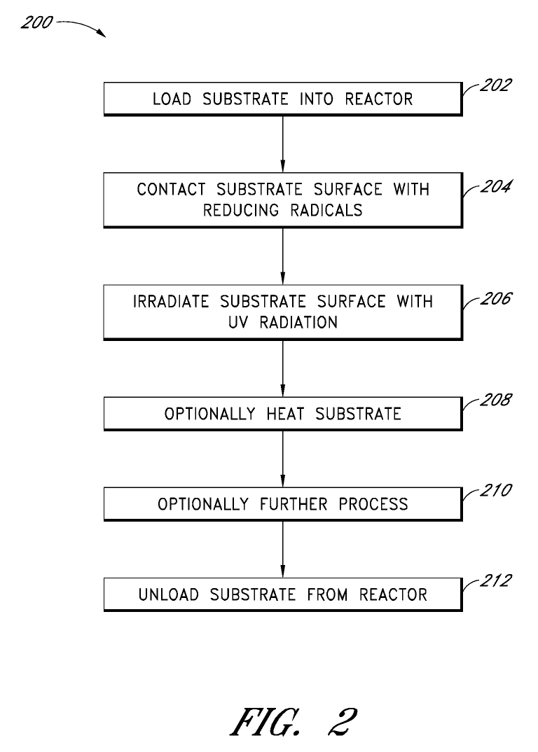

An exemplary process for cleaning the oxide from a semiconductor surface using the reactor illustrated in FIG. 2, 100, is as follows. The reactor 100 is initially in an idle mode. The gate valve is opened and the substrate 120 with a surface 122 to be cleaned is inserted into the reaction chamber 102 through the slot 124 and placed on the wafer holder 108 using a pick up device. In the illustrated embodiment, the surface 122 to be cleaned is positioned face up. The gate valve is closed.

Plasma source gas from the source 142 flows into the plasma generator 140, and is ignited to form a plasma. The selected plasma source gas generates reducing radicals. Preferably, the plasma source gas contains hydrogen, which generates hydrogen radicals. The reducing radicals flow through the plasma inlet 138 into the reaction chamber 102, over the surface 122 to be cleaned, and out the exhaust assembly 154. While the reducing radicals are in contact with the surface 122 to be cleaned, the UV sources 132 are activated, irradiating the surface 122 to be cleaned with UV radiation. The substrate is brought to temperature using the heat sources 126, 128, and/or 130. In other arrangements, the substrate may be heated by other methods known in the art. For example, the substrate 120 may be heated by the wafer holder by resistive or conductive heating. Other methods of heating the substrate 120 include convective and inductive heating.

After the oxide is cleaned from the surface 122 of the substrate 120, the plasma flow, UV radiation, and heating are discontinued. As discussed above, the order and duration of the contact with the plasma products, UV irradiation, and heating steps may be varied within the scope of the disclosed method.

The surface 122 of the substrate 120 is optionally further processed in the same reaction chamber 102 by methods well known in the art, for example, CVD or ALD. Alternatively, the substrate 120 is removed from the reactor 100 and further processed in another reactor.

A preferred embodiment of a method for cleaning oxide is illustrated in FIG. 2 and is described with reference to the device 100 illustrated in FIG. 1. Those skilled in the art will understand that other devices are also suitable for practicing the method. In step 202, a substrate 120 with a surface-to-be-cleaned 122 is loaded into the reactor 100. The surface-to-be-cleaned 122 may be an entire surface of the substrate 120, or only a portion of a surface. The surface-to-be-cleaned 122 may be any material known to be susceptible to developing an oxide surface layer, for example, single crystal silicon, polysilicon, copper, and aluminum. The material may be crystalline, polycrystalline, or amorphous.

In a preferred embodiment, the surface-to-be-cleaned 122 is a surface of a semiconductor substrate, more preferably, a semiconductor wafer, most preferably, a single crystal semiconductor wafer. The semiconductor wafer is of any type known to develop a native surface oxide layer that should be cleaned, for example, silicon, silicon-germanium, or germanium. A preferred semiconductor wafer is silicon, although germanium and/or silicon germanium wafers are also suitable. Semiconductor wafers are typically available in standard sizes, for example, about 100 mm, about 100 mm, about 300 mm, or even larger.

In another preferred embodiment, the surface-to-be-cleaned 122 is a surface of an epitaxial layer deposited on a substrate. The epitaxial layer is of any type known to develop a surface oxide layer, for example, silicon, silicon-germanium, or germanium. A preferred epitaxial layer is epitaxial silicon. The substrate 120 may be of any type known in the art, for example, a semiconductor substrate or an insulator substrate, for example, a glass, silica, or sapphire substrate. Glass substrates are used in such applications as the fabrication of liquid crystal displays.

In another preferred embodiment, the surface-to-be-cleaned 122 is a conductor surface, for example, copper or aluminum.

In a preferred embodiment, a semiconductor surface 122 is precleaned before the substrate is inserted in the reactor 100 by any suitable method known in the art. For example, a silicon wafer may be ex situ precleaned by wet cleaning, preferably, using the SC-1, SC-2, HF last procedure. Alternatively, a silicon wafer may be dry etched, for example, using HF vapor treatment. In yet another preferred embodiment, the surface 122 is not precleaned before loading in the reactor 100.

The reactor 100 may be of any type known in the art that is compatible with the disclosed method. Because the cleaned surface 122 of the substrate may be reoxidized if exposed to oxygen, in a preferred embodiment, a subsequent processing step is performed in the same reaction chamber 102 as the oxide cleaning process, for example, chemical vapor deposition (CVD), atomic layer deposition (ALD), physical vapor deposition (PVD), molecular beam epitaxy (MBE), or ion implantation. In another preferred embodiment, subsequent processing is not performed in the reactor 100 in which the cleaning is performed. For example, the cleaning reactor 100 may be a module in a cluster tool configured for post-cleaning processing in a separate tool.

In step 204, the semiconductor surface 122 is contacted with reducing radicals, preferably hydrogen radicals. The radicals are preferably generated using a plasma generator 140. The plasma is generated by at least one of within the reactor itself and in a remote plasma source in fluid communication with the reactor. Preferably, the plasma is generated remotely from the reaction chamber 102, i.e., the reactor is a downstream plasma generator 140. An example of a commercially available remote plasma generator suitable for use in the disclosed method is model TR-850 by Rapid Reactive Radicals Technology (R3T) GmbH of Munich, Germany. The concentration of highly energetic particles in plasma, such as ions and electrons, typically decreases as the plasma travels from the plasma generator 140 to the reaction chamber 102. These energetic particles may physically damage the surface of the substrate, as well as exposed surfaces of the reaction chamber 102 itself. On the other hand, increasing the time between the plasma generation and contact with the surface-to-be-cleaned 122 reduces the concentration of hydrogen radicals contacting the surface-to-be-cleaned 122 through recombination. The rate of recombination is affected by factors known in the art, including the distance between the plasma generator 140 and the reaction chamber 102, the material from which the conduit between the plasma generator 140 and the reaction chamber 102 is constructed, and pressure. Reducing the hydrogen radical concentration can reduce the rate of oxide reduction. Consequently, the plasma generator 140 is preferably positioned to reduce substrate damage while maintaining an acceptable cleaning rate. Consequently, in preferred embodiments, the plasma generator 140 is configured to optimize delivery of neutral radicals to the reaction chamber 102, while reducing the concentration of ions and/or radical ions contacting the surface-to-be-cleaned 122.

A plasma, either generated remotely or within the reactor 102, is generated by any means known in the art, for example, by applying energy to a plasma source gas 142, such as with a magnetron, a helicon, an electron cyclotron resonance (ECR) device, or an electron beam. Typically, the energy is radio frequency (RF) or microwave energy generated by a magnetron. In the disclosed method, the plasma source gas 142 is a source of reducing radicals. Preferably, the reducing radicals are hydrogen radicals and the plasma source gas 142 is hydrogen. The plasma source gas 142 optionally includes an inert gas, that is, a gas that the plasma of which does not react with the semiconductor surface, and that does not itself react with the semiconductor surface, but aids in the formation of the plasma. In a preferred embodiment, an inert gas is selected that reduces the rate of recombination of hydrogen radicals. Examples of suitable inert gases include water vapor, helium, neon, argon, and nitrogen. Preferably, the inert gas is helium or argon. The inert gas may be mixed with the plasma source gas 142 before the plasma is generated, either using a premixed gas mixture; just prior to plasma generation; or within the plasma generator. In another preferred embodiment, an inert gas is mixed with the plasma after the plasma is generated. Preferably, the inert gas is incorporated within the plasma source gas 142 prior to plasma generation. In a preferred embodiment, the concentration of hydrogen in the inert gas is preferably from about 2% to about 100%, more preferably, about 40-60% (e.g., about 50%). The flow rate will vary depending on factors including the concentration of hydrogen radicals, the presence of an inert gas, the pressure, the size of the reaction chamber 102, the intensity of the UV irradiation, the temperature, the particular substrate, and the particular wet cleaning method used on the substrate 120. An appropriate flow rate may be determined by one of ordinary skill without undue experimentation. For a 7.5 L reaction chamber described below for 100-mm wafers, single-crystal silicon wafers cleaned using SC-1 and an HF dip, a hydrogen radical concentration of about 10¹⁶ atoms/cm⁻³ in helium at <0.5 torr, at about 300° C., the flow rate is preferably from about 10 sccm to about 300 sccm, more preferably, about 150 sccm.

The frequency of the microwave radiation will depend on the particular plasma source gas used. The plasma may be generated with low-frequency (kHz) or high-frequency (MHz or GHz) RF energy. The energy applied may be at a single frequency or at two or more frequencies. Preferred frequencies are from about 13.56 MHz or about 2.45 GHz. The power of the microwave radiation is preferably from about 100 W to about 10,000 W, more preferably, from about 500 W to about 3000 W or from about 100 W to about 1000 W. The power will depend on factors including the desired concentration of radicals, the flow rate, the pressure, the size of the reaction chamber, the composition of the plasma source gas, the configuration of the connection between a remote plasma source and the reaction chamber, and the like.

For example, a plasma may be generated from hydrogen in helium at from about 40 kHz to about 2.45 GHz. For a plasma source gas of 50% hydrogen in helium at 0.1 torr generated remotely from the reaction chamber and the 7.5 L reactor described below, the power is preferably from about 1000 W to about 3000 W. For a plasma source gas of about 50% hydrogen in an inert gas or an inert gas mixture at a pressure of about 0.1 torr and a flow rate of about 150 sccm, the microwave energy is preferably about 500 W at about 13.56 MHz. Suitable inert gases are known in the art, for example, He, Ar, Xe, Ne, Kr, N₂, combinations thereof, and the like. In some preferred embodiments, the pressure of the plasma is from about 0.1 torr to about 3 torr. Preferably, the concentration of hydrogen radicals is from about 2% to about 100%, based on the concentration of hydrogen in the feed gas.

In step 206, the semiconductor surface 122 is irradiated with UV radiation using, for example, UV sources 132. The irradiation is preferably concurrent with the contact with the radicals in step 104, as is described in greater detail below. The UV radiation has an energy sufficient to clean the particular surface under the particular cleaning conditions. Preferably, the wavelength is from about 100 nm to about 400 nm, more preferably, from about 146 nm to about 122 nm, or from about 146 nm to about 193 nm. For a silicon substrate, the wavelength is preferably from about 172 nm to about 193 nm.

The intensity of the UV radiation is selected to provide effective cleaning of the semiconductor surface. All other things being equal, increasing the intensity increases the cleaning rate up to maximum rate for a particular combination of conditions, for example, hydrogen radical concentration, temperature, substrate, and UV wavelength, is reached.

The UV source 132 may be of any type that provides the desired wavelength and intensity of UV radiation. Examples of suitable sources include low pressure and high pressure lamps, excimer lamps, microwave excited UV plasma, electrodeless lamps, and lasers. Another suitable source is a microdischarge device, described in El-Hibachi and Schoenbach Appl. Phys. Lett. 1998, 73(7); Frame et al. Appl. Phys. Lett. 1997, 71(9); and International Patent Publication WO 98/53480 A1 to Detemple et al., all of the disclosures of which are incorporated by reference. Suitable UV radiation is produced by certain plasmas, for example, hydrogen, helium, and/or argon plasmas. Plasmas comprising hydrogen as a plasma source gas are preferred because the emission of such plasmas is coincident with the absorption of hydrogen gas that leads to hemolytic cleavage of the hydrogen-hydrogen bond. Consequently, a plasma in a plasma chamber with a UV transparent wall adjacent to the reaction chamber is also a suitable UV source, an embodiment of which is described in greater detail below. Some embodiments use a combination of UV sources.

In a preferred embodiment, the UV source 132 is located outside of the reaction chamber 102 and at least a portion of the reaction chamber is made from a material transparent or translucent to UV radiation, for example, quartz and/or sapphire. Quartz is transparent to UV radiation with wavelengths of about 180 nm or greater. The reactor chamber 102 may be equipped with an optical system configured to illuminate the substrate 120 with UV radiation. The optical system may include any type of optical component known in the art, including windows, mirrors, lenses, prisms, fiber optics, optical waveguides, gratings, and the like. In a preferred embodiment, the optical system is a portion of the reactor transparent to the UV radiation. In one preferred embodiment, the reaction chamber 102 comprises a material opaque to UV radiation, for example, stainless steel, frosted quartz, or black quartz, and equipped with one or more windows that are transparent to UV, for example, quartz. Reactors comprising quartz windows are well known in the art. In another preferred embodiment, the reaction chamber 102 is substantially all quartz. Quartz reaction chambers are well known in the art, for example, the Epsilon® reactor (ASM International, Bilthoven, NL) discussed below. Preferably, the entire surface-to-be-cleaned 122 in simultaneously irradiated. In another preferred embodiment, only a portion of the surface 122 is irradiated at any given time and the substrate 120 is moved during the cleaning process to irradiate the entire surface, for example, using a turntable. In another embodiment, UV radiation scans the surface-to-be-cleaned 122.

In another preferred embodiment, a UV source 132 is situated within the reaction chamber 102. One advantage of positioning a UV source 132 within the reaction chamber 102 is that the source may be positioned closer to the substrate 120, thereby increasing the intensity of the radiation incident to the substrate 120, all other factors remaining equal. Another advantage is that radiation with wavelengths shorter than the UV cutoff of the optical system described above may be used. Disadvantages of placing the UV source 132 within the reaction chamber 102 include reduced accessibility for servicing, difficulty in cleaning, reliability of the source, and disruption of laminar flow. Other embodiments comprise a plurality of UV sources 132 in any combination of outside the reaction chamber 102 and/or inside the reaction chamber 102.

In step 208, the substrate 102 is optionally heated, for example, using heater sources 126, 128, and/or 130. In some embodiments, the substrate 102 is not heated. In embodiments comprising heating, the heating is preferably concurrent with the contact with radicals in step 204 and the irradiation in step 206, as is described in greater detail below. The temperature to which the substrate 102 is heated will depend on factors including the type of substrate, the intensity of the UV radiation, the hydrogen plasma concentration, and the thermal budget of the device. A silicon substrate is preferably heated to a temperature of not greater than about 700° C. or less, more preferably, not greater than about 550° C., most preferably, not greater than about 500° C., especially, not greater than about 450° C. The substrate 102 may be heated by any means known in the art, for example, radiant heating, inductive heating, and/or resistive heating. In a preferred embodiment, the substrate 102 is heated by radiant heating. Radiant heating sources are typically heat lamps with a quartz envelope enclosing a tungsten filament and a halogen gas, typically iodine. The output of these sources is typically from about 0.8 μm to about 1.2 μm, in the short-wave IR region. The lamps output extends into the visible region, but have no significant intensity in the UV.

Advantageously, the use of UV and plasma energy facilitates lower temperatures for the native oxide cleaning. Not only can the wafer 102 be cleaned at lower temperatures, but the chamber 102 or substrate support 108 can also idle between processes at lower temperatures (preferably less than 500° C. and more preferably less than 450° C.). In contrast, loading a wafer 102 upon a hot substrate support 108 instantly desorbs the protective hydrogen termination from the wafer surface 122 (e.g., formed in an “HF last” treatment), and the hot wafer 102 is potentially exposed to moisture or other contamination before the chamber 102 can be fully purged. Thus, with the lower temperatures afforded by some preferred embodiments, a wafer that has been ex situ precleaned and provided with a hydrogen termination can maintain that termination after loading and purging. Until the energetic cleaning process begins, the hydrogen termination protects the wafer 102 from moisture and other contaminants in the chamber. Furthermore, the cleaning process itself can leave a hydrogen termination.

Steps 204, 206, and 208 may be initiated and terminated in any order. In certain preferred embodiments, the three steps begin and end substantially contemporaneously. In other preferred embodiments, one or more of the steps begins before the others and/or ends before the others. In preferred embodiments, all three steps—the plasma, UV irradiation, and heating—overlap for at least some period of time. Those skilled in the art will appreciate that the time required to clean a surface will depend on factors including the type of substrate, thickness of oxide, concentration of hydrogen radicals, wavelength of UV radiation, intensity of UV radiation, and temperature. For a silicon substrate, the time is preferably less than about 120 s, more preferably, less than about 60 s, most preferably, less than about 30 s, especially, less than about 15 s.

In preferred embodiments, after steps 204, 206, and 208, a surface 122 of the substrate is substantially clean of native oxide. As discussed above, in some embodiments, at least a portion of the cleaned surface is a hydrogen terminated silicon surface, which is typically stable to up to temperatures of from about 500° C. to about 550° C.

In optional step 210, the surface 122 is further processed, for example, by deposition of one or more layers on the cleaned surface 122. In some preferred embodiments, the additional layer(s) are deposited within the same reaction chamber 102 as the cleaning, that is, an in situ deposition. Some of these embodiments feature reduced substrate 120 handling and/or reduced likelihood of recontamination of the cleaned surface 122, which improve throughput and/or yields. In some of these embodiments, the additional layer(s) are formed substantially immediately after the surface 122 is cleaned. In other embodiments, additional layers are deposited in a different reaction chamber, for example, using a cluster tool comprising separate cleaning and deposition tools. Preferably an epitaxial layer, for example, silicon, germanium, silicon-germanium, combinations thereof, and the like, is deposited upon the cleaned surface 122, such that native oxide, which was cleaned from the substrate in steps 104, 106, and 108, does not interfere with crystal alignment in the epitaxially deposited layer. The additional layer(s) are deposited using one or more suitable methods known in the art, for example, by chemical vapor deposition (CVD), by a CVD-type process, by atomic layer deposition (ALD), by an ALD-type process, by molecular beam epitaxy (MBE), by physical vapor deposition (PVD), ion implantation, and/or combinations or variants thereof.

In a preferred embodiment, the deposition is by CVD or a CVD-type process known in the art, for example, by UV-assisted CVD. In some embodiments, at least a portion of the UV radiation in a UV-assisted CVD process is generated in a plasma glow discharge from a remote plasma, as discussed in greater detail below. In some embodiments, at least a portion of the UV radiation in a UV-assisted CVD is generated using one or more lamps, as discussed above. Some embodiments use a combination of UV sources. In another preferred embodiment, the deposition is by ALD or an ALD-type process.

In step 212, the substrate 120 is removed from the reactor 102.

In other embodiments, in step 206, the surface-to-be-cleaned 122 is irradiated using an in situ plasma as a UV source. The plasma electrodes are positioned such that the substrate 120 substantially does not contact energetic ions formed in the plasma discharge, which can damage the surface 122 of the substrate. Accordingly, in some preferred embodiments, no voltage bias is applied to the substrate 120 so as not to attract energetic ions. In other embodiments, a positive bias is applied to the substrate 120, which repels energetic ions. In some preferred embodiments, the plasma is formed above the surface 122, for example. Those skilled in the art will understand that other arrangements are possible.

In some embodiments, a substantial number of radicals formed in the plasma discharge also do not contact the surface 122 in step 204, because the majority of radicals formed in the glow discharge recombine before contacting the surface 122. In some embodiments, substantially no radicals formed in the plasma discharge contact the surface 122. Accordingly, in some embodiments, most or all of the radicals contacting the surface 122 in step 204 are generated by UV cleavage of molecules at or near the surface 122, for example, of molecular hydrogen. Accordingly, in embodiments of this method, a surface-to-be-cleaned 122 is contacted with radical precursor, for example, hydrogen gas, and in step 204, the surface 122 contacted with radicals formed by UV irradiation of the radical precursor. In some embodiments, the UV source is an in situ plasma discharge. In some embodiments, substantially no radicals generated in the plasma discharge contact the surface 122 in step 204.

In some preferred embodiments, the plasma generating gas comprises hydrogen gas and another gas that facilitates plasma formation, for example, argon and/or neon. Those skilled in the art will appreciate that the emission spectrum from the glow discharge of hydrogen matches the absorption spectrum of molecular hydrogen, thereby efficiently generating hydrogen radicals from hydrogen molecules proximal, at, or near the surface 122. Among the advantages of using an in situ plasma discharge as the UV source is that the method may be practiced in existing reaction chambers without modification. Another advantage is the potential high-intensity of the UV radiation because a reduced distance between the plasma and the substrate 120.

Without being bound by any theory, it is believed that the oxide cleaning process proceeds by at least one of the following three mechanisms.

First, the bandgap of silicon is about 1 eV. UV photons have energies of from about 3 eV (413 nm) to about 5 eV (148 nm). UV irradiation of the silicon surface generates electron-hole pairs. These unpaired electrons react with the hydrogen radicals forming either oxygen-hydrogen bonds or silicon-hydrogen bonds. The hydroxyl group is an intermediate to water, the final oxygen containing byproduct, which is advantageously vaporized under the preferred reaction conditions, and the silicon-hydrogen group is final surface species of the cleaned surface.

Second, absorbing a UV photon may promote a semiconductor-oxygen bond into an excited state. The excited state may be more reactive with hydrogen radicals than the ground state substrate-oxygen bond.

Third, absorption of the UV photons may generate phonons. These phonons cause local heating of the surface-to-be-cleaned, thermally activating the reduction of the oxide. The heating is highly localized and does not appreciably heat the bulk of the substrate. Consequently, this localized heating does not significantly contribute to the energy budget. For example, the bulk heating is insufficient to relax sensitive epitaxial layers, such as silicon-germanium on silicon.

The addition of a photochemical processes to the thermal process in the disclosed oxide cleaning method permits the use of lower temperatures. In certain preferred embodiments, the oxide cleaning is performed at temperatures under which the hydrogen passivated surface is stable, allowing simultaneous cleaning and passivation of the surface. For example, the cleaning may be performed at 450° C. or below for a silicon surface. Because the passivated surface resists reoxidation, the substrate may be safely transferred to another reactor for further processing, for example, deposition, thereby increasing throughput of the deposition reactor. In this embodiment, the cleaning reactor is a dedicated bake station, which could be stand-alone or clustered.

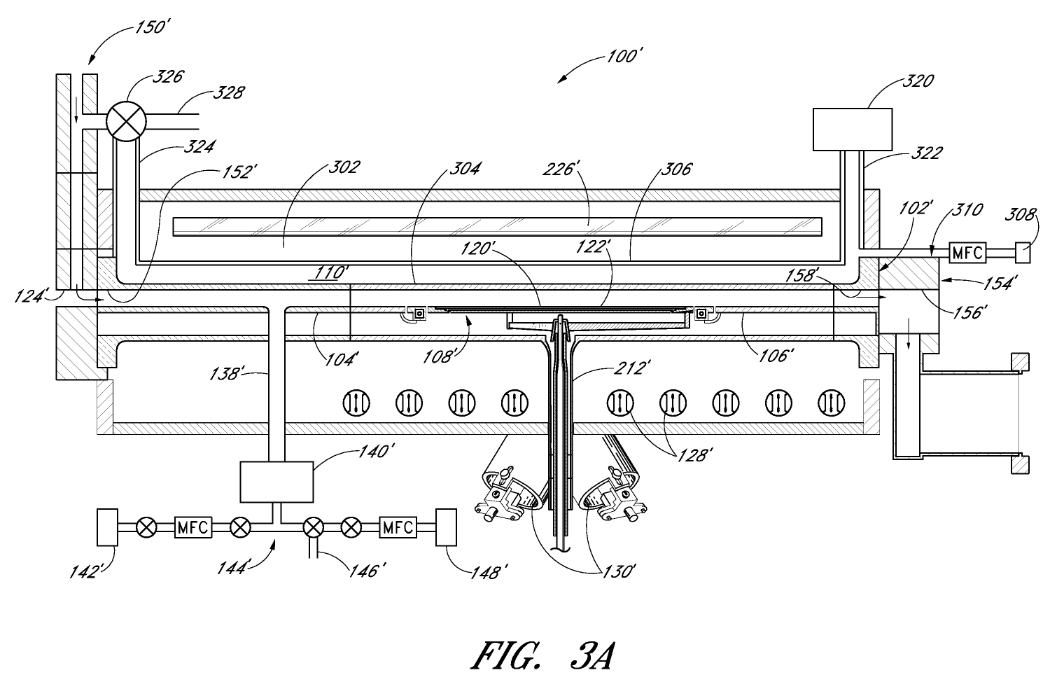

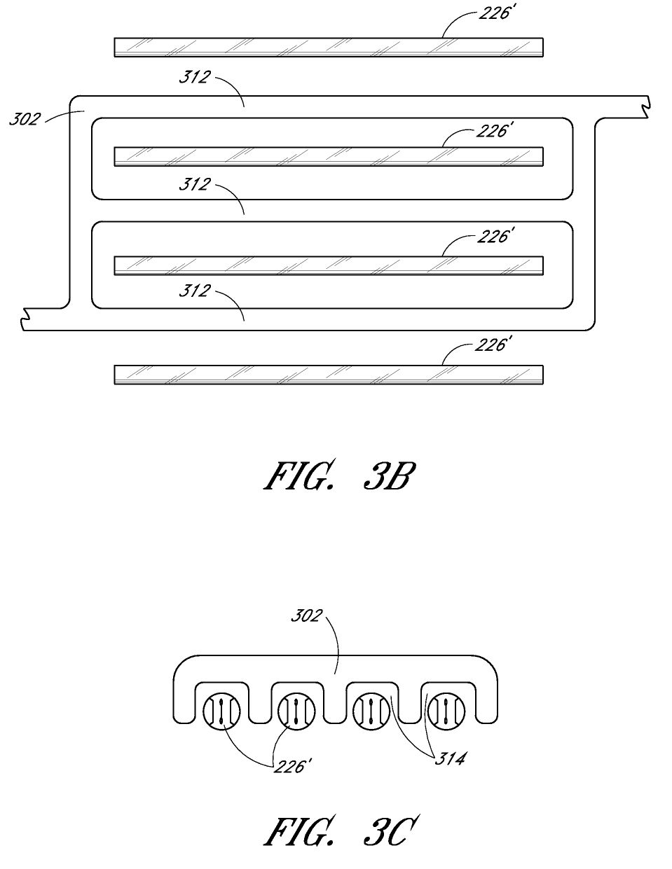

FIG. 3A illustrates another preferred embodiment of a reactor useful for cleaning oxide. The illustrated reactor 100′ is similar to the reactor 100 illustrated in FIG. 1, except that the UV source is the glow discharge from a plasma. Consequently, components analogous to those of the embodiment illustrated in FIG. 1 are indicated with primed reference numbers. Unless otherwise specified, the descriptions are also analogous. Other embodiments comprise both UV lamps and remote plasma chambers as UV sources.

Positioned above a reaction chamber 102′ is a remote plasma chamber 302. Between the plasma chamber 302 and reaction chamber is a lower window 304 that is transparent to UV radiation. In a preferred embodiment, the lower window 304 is quartz. The upper window 306 is made from a material that is transparent to the thermal radiation generated by the heat source 126′. A source of a plasma source gas 308 is fluidly connected to the plasma chamber 302 through a manifold 310. In the illustrated embodiment, the plasma source gas is controlled through a mass flow controller, although any known means of controlling the gas flow may be employed. Those skilled in the art will understand that the manifold 310 may have multiple gas inputs. Any plasma source gas may be used that generates a plasma with a glow discharge in the ultraviolet with a wavelength that is effective for cleaning oxide from a substrate. Preferred plasma source gases contain hydrogen, helium, or argon. Particularly preferred are plasma source gases containing hydrogen, which may be used as a source of reducing radicals, as is discussed in greater detail below. Those skilled in the art will understand that the disclosed apparatus may comprise one or more plasma chambers.

In the illustrated embodiment of FIG. 3A, the plasma chamber 302 is positioned between the heat source 126′ and the reaction chamber 102′. Those skilled in the art will understand that other configurations of these three components are also possible. For example, the heat source 126′ may be positioned between the plasma chamber 302 and the reaction chamber 102′. In other embodiments, the plasma chamber 302 and the heat source 126′ are generally coplanar. For example, one of the plasma chamber 302 or the heat source 126′ may be positioned over the wafer support 108′ and other arranged around the periphery. In another embodiment illustrated in FIG. 3B, the plasma chamber 302 is fabricated as a series of generally parallel tubes 312 between which one or more heat sources 126′ may be disposed. Those skilled in the art will understand that other geometries for the plasma chamber are also suitable, for example, spiral and/or concentric tubes. In the embodiment illustrated in cross-section in FIG. 3C, one or more heat sources 126′ are situated in pockets 314 formed in the plasma chamber 302.

Referring again to FIG. 3A, plasma is generated in the plasma chamber 302 by coupling energy from any suitable energy source 320 to the plasma source gas. Suitable conditions for forming a plasma are discussed above. Preferred frequencies are from about 13.56 MHz or about 2.45 GHz. Preferred energies are from about 100 W to about 1000 W. Those skilled in the art will understand that the UV output of the plasma is also related to the particular plasma source gas used, its pressure, and its flow rate. For a plasma source gas of about 50% hydrogen in an inert gas or an inert gas mixture at a pressure of about 0.1 torr and a flow rate of about 150 sccm, the microwave energy is preferably about 500 W at about 13.56 MHz.

The plasma and products thereof exit the plasma chamber 302 through a plasma outlet 324. In the illustrated embodiment, the plasma outlet 324 terminates at a valve 326, which has at least three positions. In a first position, the valve 326 is closed. In a second position, the valve 326 provides a fluid connection between the plasma outlet 324 and the plasma exhaust 328, through which plasma and plasma products may be drawn, typically by a vacuum source. In a third position, the valve 326 provides a fluid connection between the plasma outlet 324 and an inlet assembly 150′, allowing plasma and plasma products to enter the reaction chamber 102′. The plasma outlet 324, valve 326, and inlet assembly 150′ are preferably configured to optimize the concentration of reducing radicals in the reaction chamber 102′ while simultaneously minimizing the concentration of damaging energetic particles such as ions and/or radical ions. In another preferred embodiment (not illustrated), plasma and plasma products flow into the reaction chamber 102′ from the plasma outlet 324 through a port other than the inlet assembly 150′. Those skilled in the art will understand that other embodiments use other arrangements for fluidly controlling the contents of the plasma chamber 302

As described above, the illustrated reactor 100′ is optionally equipped with a remote plasma generator 140′ in fluid connection with a one or more sources of plasma source gas 142′, 146′, or 148′ through a manifold 144′.

An exemplary process for cleaning the oxide from a semiconductor surface using the reactor illustrated in FIG. 3A, 100′, is as follows. The reactor 100′ is initially in an idle mode. The gate valve is opened and the substrate 120′ with a surface 122′ to be cleaned is inserted into the reaction chamber 102′ through the slot 124′ and placed on the wafer holder 108′ using a pick up device. In the illustrated embodiment, the surface 122′ to be cleaned is positioned face up. The gate valve is closed.

A plasma is generated in the plasma chamber 302 from a plasma source gas from source 308 and energy from the microwave source 320. The plasma source gas is selected that provides a plasma with a glow discharge in the UV region. In the illustrated embodiment, the plasma also produces reducing radicals. Preferably, the plasma source gas contains hydrogen, which generates hydrogen radicals. UV radiation from a glow discharge of the plasma in the plasma chamber 302 irradiates the surface-to-be-cleaned 122′. The valve 326 is positioned to fluidly connect the plasma outlet 324 to the inlet assembly 150′. The reducing radicals flow into the reaction chamber 102′ through the inlet assembly 150′ and inlet port 152′, over the surface-to-be-cleaned 122′, and out the exhaust assembly 154′. However, the window 304 prevents a direct, line-of-sight path for the plasma products to reach the surface-to-be-cleaned 122′. Optionally, the concentration of reducing radicals is supplemented using a remote plasma generator 140′, the operation of which is described above.

The substrate is brought to temperature using the heat sources 126′, 128′, and/or 130′. In other arrangements, the substrate may be heated by other methods known in the art. For example, the substrate 120′ may be heated by the wafer holder by resistive or conductive heating. Other methods of heating the substrate 120′ include convective and inductive heating. In other embodiments, the substrate is not heated.

In other embodiments, the plasma chamber 302 is used as a UV source and not used as a source of reducing radicals. In some of these embodiments, the plasma is generated using a gas or mixture of gases that does not form reducing radicals, for example, inert gases including helium, argon, nitrogen, and mixtures thereof. In some of these embodiments, the remote plasma generator 140′ is the source of reducing radicals.

After the oxide is cleaned from the surface 122′ of the substrate 120′, the plasma flow, UV radiation, and heating are discontinued. As discussed above, the order and duration of the contact with the plasma products, UV irradiation, and heating steps may be varied within the scope of the disclosed method.

The surface 122′ of the substrate 120′ is optionally further processed in the same reaction chamber 102′ by methods well known in the art, for example, CVD or ALD, as discussed above. Alternatively, the substrate 120′ is removed from the reactor 100′ and further processed in another reactor.

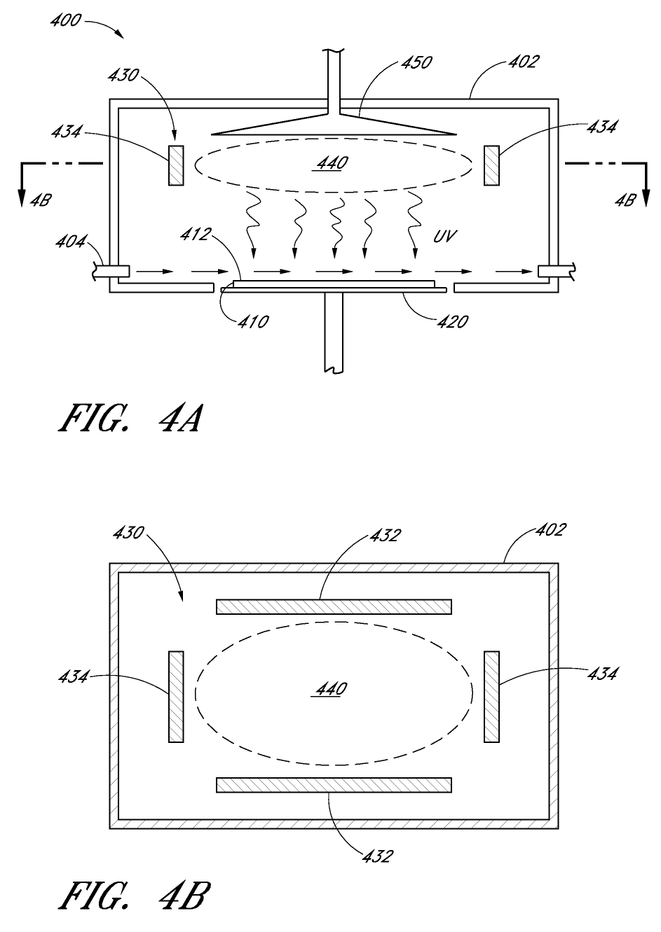

FIG. 4A is a cross-sectional view of an embodiment of a reactor 400 in which an in situ plasma is used as a source of UV radiation, which is suitable for use in embodiments of the method 200, as well as in other methods. In embodiments of the illustrated embodiment, the in situ plasma is not itself a direct source of most of the reducing radicals. The reactor 400 comprises a reactor chamber 402 in which is disposed substrate support 420 of any type known in the art, for example, a susceptor. A substrate 410 comprising a surface-to-be-cleaned 412 is disposed on the substrate support 420. Positioned within the chamber 402 above the substrate support is a plasma discharge assembly 430, which is capable of generating a plasma glow discharge 440 that delivers UV radiation (indicated by the wavy vertical arrows) sufficient to clean the surface-to-be-cleaned 412 of the substrate as described above. The plasma 440 is generated from a plasma source gas delivered through a suitable gas inlet 450. As discussed above, the plasma source gas preferably comprises H₂. The reactor also includes a separate inlet 404 through which a reducing gas, for example, H₂, is delivered to the substrate 410 independently of the plasma source gas supply. The flow of the reducing gas over the substrate 410 is indicated by the horizontal arrows.

FIG. 4B is a top view of the plasma discharge assembly 430. In the illustrated embodiment, the plasma discharge assembly 430 comprises a set of RF electrodes 432, used for generating the glow discharge 440, and a set of magnets 434, which confines the glow discharge 440 to the desired region. In preferred embodiments, the strength and/or shapes of the magnetic fields of the magnets 434 are adjustable using means known in the art to permit optimization of the glow discharge 440 region. In preferred embodiments, the glow discharge 440 region is substantially confined by the magnets 434, substantially preventing the radicals generated therein from reaching the substrate 410. Thus, the magnets 434 prevent a direct, line-of-sight path for the plasma products to reach the surface-to-be-cleaned 412′. The RF electrodes 432 are coupled to a source of RF power (not illustrated) suitable for generating the desired plasma. Those skilled in the art will understand that other arrangements are also useful for generating and positioning a suitable plasma glow discharge.

Situating the irradiation source within the reaction chamber 402 provides certain advantages, for example, a short distance between the plasma discharge assembly 430 and the surface-to-be-cleaned 412, and/or no intervening structures between the plasma discharge assembly 430 and the surface-to-be-cleaned 412.

An embodiment of the process 200 for cleaning oxide from a substrate 410 using the reactor 400 of FIGS. 4A and 4B is briefly described herewith. In step 202, a substrate 410 is loaded on the substrate support 420.

In steps 204 and 206, the surface-to-be-cleaned 412 of the substrate 410 is irradiated with UV radiation, thereby forming reducing radicals in contact therewith, for example, hydrogen radicals. In the illustrated embodiment, hydrogen radicals are generated at the surface 412 from a suitable precursor, for example, molecular hydrogen (H₂), disposed at or near the surface 412. For example, in some embodiments, a substantially horizontal flow of hydrogen gas is directed over the substrate 410. The hydrogen at the surface 412 is then irradiated with radiation suitable for generating hydrogen radicals from the hydrogen gas.

In the illustrated embodiment, the glow discharge 440 is generated by the plasma discharge assembly 430. As discussed above, in some preferred embodiments, the source of the radiation is a glow discharge generated from hydrogen gas, which, because the UV radiation is formed from the in situ plasma breakdown of H₂ into H radicals, emits radiation with exactly the right wavelength to be absorbed by, break down and activate the separate supply of H₂ gas at the substrate surface 412. Accordingly, in preferred embodiments, the gas from which the glow discharge 430 is generated comprises hydrogen gas, preferably, in admixture with one or more inert gases, as discussed in greater detail above. Suitable conditions for generating the plasma 430 are known in the art, and are discussed above. The RF power to the electrodes 432 and the magnetic fields of the magnets 434 are adjusted to provide a sufficient intensity of UV radiation to the surface 412 of the substrate for effective cleaning. It is believed that the UV radiation also assists the reaction of oxide with the reducing radicals in some embodiments.

In step 208, the surface 412 is optionally heated as described above.

After the oxide is cleaned from the surface 412, the surface is then optionally further processed in step 210 as described above, and unloaded from the reactor 400 in step 212.

The embodiments illustrated and described above are provided as examples of certain preferred embodiments of the present invention. Various changes and modifications can be made to the embodiments presented herein by those skilled in the art without departure from the spirit and scope of this invention, the scope of which is limited only by the claims appended hereto.

I claim:

1. A method of cleaning oxide from a surface-to-be-cleaned in the fabrication of an integrated device, the method comprising:
contacting a surface-to-be-cleaned comprising oxide with remotely generated reducing radicals, and
irradiating the surface-to-be-cleaned with UV radiation.

2. The method of claim 1, wherein the surface-to-be-cleaned is a surface of a semiconductor.

3. The method of claim 2, wherein the semiconductor comprises a single-crystal semiconductor.

4. The method of claim 2, wherein the semiconductor comprises silicon.

5. The method of claim 2, wherein the semiconductor comprises silicon-germanium.

6. The method of claim 2, wherein the semiconductor is an epitaxial layer.

7. The method of claim 4, wherein the epitaxial layer is supported on a semiconductor.

8. The method of claim 4, wherein the epitaxial layer is supported on an insulator.

9. The method of claim 8, wherein the insulator comprises at least one of silica and sapphire.

10. The method of claim 1, wherein the surface-to-be-cleaned comprises a surface of a conductor.

11. The method of claim 10, wherein the conductor comprises copper.

12. The method of claim 1, further comprising precleaning the surface-to-be-cleaned prior to the cleaning process.

13. The method of claim 12, wherein the precleaning comprises at least one of an ex situ wet cleaning and a dry etch.

14. The method of claim 1, further comprising heating the surface-to-be-cleaned.

15. The method of claim 14, wherein the surface is heated to a temperature that is not greater than about 550° C.

16. The method of claim 15, wherein the temperature is not greater than about 500° C.

17. The method of claim 16, wherein the temperature is not greater than about 450° C.

18. The method of claim 1, wherein the surface-to-be-cleaned is not heated.

19. The method of claim 1, wherein the reducing radicals comprise hydrogen radicals.

20. The method of claim 19, wherein the hydrogen radicals are the products of a plasma.

21. The method of claim 20, wherein the plasma is generated from a plasma source gas comprising hydrogen.

22. The method of claim 20, wherein the plasma source gas further comprises an inert gas.

23. The method of claim 22, wherein the inert gas comprises at least one of He, Ar, Xe, O₂, Ne, and Kr.

24. The method of claim 1, wherein the pressure of the plasma is from about 0.1 torr to about 3 torr.

25. The method of claim 19, wherein the concentration of hydrogen radicals is from about 2% to about 100%.

26. The method of claim 19, wherein a hydrogen terminated surface is formed on the surface-to-be-cleaned.

27. The method of claim 26, further comprising heating the surface-to-be-cleaned to a temperature at which the hydrogen terminated surface is stable.

28. The method of claim 1, wherein the UV radiation is from about 100 nm to about 400 nm.

29. The method of claim 28, wherein the UV radiation is from about 146 nm to about 193 nm.

30. The method of claim 1, wherein a source of at least a portion of the UV radiation comprises an excimer lamp.

31. The method of claim 1, wherein a source of at least a portion of the UV radiation comprises a remote plasma.

32. The method of claim 1, further comprising forming a layer on the surface-to-be-cleaned wherein the contacting, irradiating, and forming are performed in a single reaction chamber.

33. The method of claim 32, wherein the layer is formed by a method comprising chemical vapor deposition.

34. The method of claim 33, wherein the chemical vapor deposition is UV-assisted chemical vapor deposition.

35. The method of claim 34, wherein a plasma glow discharge is a source of at least a portion of the UV radiation in the UV assisted chemical vapor deposition.

36. The method of claim 35, wherein the plasma is an in situ plasma.

37. The method of claim 32, wherein the layer is formed by a method comprising atomic layer deposition.

38. The method of claim 32, wherein the layer comprises at least one of epitaxial silicon, epitaxial germanium, or epitaxial silicon-germanium

39. A reactor for fabricating an integrated device, the reactor comprising a source of reducing radicals and a source of UV radiation, wherein the source of UV radiation comprises an excimer UV lamp.

40. The reactor of claim 39, further comprising a heat source.

41. The reactor of claim 39, wherein the source of reducing radicals is a plasma source.

42. The reactor of claim 41, wherein the plasma source is a remote plasma source.

43. A reactor for fabricating an integrated device, the reactor comprising:
a plasma chamber, and
a reaction chamber dimensioned and configured for processing a substrate therein, wherein
the plasma chamber is dimensioned and configured to irradiate a substrate within the reaction chamber with UV radiation generated by a plasma within the plasma chamber, and
the plasma chamber is in fluid connection with the reaction chamber.

44. The reactor of claim 43, wherein the fluid connection between the plasma chamber and the reaction chamber is optimized to provide neutral radicals to the reaction chamber.

45. The reactor of claim 43, further comprising an energy source configured to generate a plasma within the plasma chamber.

46. The reactor of claim 43, wherein at least one of the plasma chamber and reaction chamber comprises quartz.

47. The reactor of claim 43, further comprising a heat source dimensioned and configured to heat the substrate.

48. The reactor of claim 47, wherein the heat source is a radiant heat source.

49. A method for cleaning oxide from a semiconductor surface in the fabrication of an integrated device, the method comprising:
generating a plasma glow discharge within a reactor from a plasma gas supply, the plasma glow discharge emitting UV radiation;
preventing a direct line-of-sight path for products of the plasma glow discharge to the semiconductor surface;
exposing an H₂ gas to the UV radiation from the plasma glow discharge, wherein the H₂ is provided separately from the plasma gas supply; and
contacting the semiconductor surface with the H₂ gas activated by the UV radiation from the plasma glow discharge.

50. The method of claim 49, further comprising heating the surface-to-be-cleaned.

51. The method of claim 49, wherein the plasma gas supply comprises H₂ gas.

52. The method of claim 49, wherein preventing the direct line-of-sight path comprises confining the plasma glow discharge with magnets.

53. The method of claim 49, wherein preventing the direct line-of-sight path comprises providing a transparent window between the plasma glow discharge and the semiconductor surface.
